(19) United States
(12) Patent Application Publication
(10) Pub. No.: US 2016/0200994 A1
(43) Pub. Date: Jul. 14, 2016

(54) APPARATUS AND METHOD FOR REMOVING MOISTURE AND IMPURITIES FROM FUEL OIL

(71) Applicant: Jun JIANG, Richmond (CA)

(72) Inventor: Jun JIANG, Richmond (CA)

(21) Appl. No.: 14/670,917

(22) Filed: Mar. 27, 2015

(30) Foreign Application Priority Data
Jan. 9, 2015 (CA) 2877377

(51) Int. Cl. C10L 1/08; B01D 35/30; F02M 37/22; B01D 29/56

(52) U.S. Cl. CPC C10L 1/08; B01D 29/56; B01D 35/30; F02M 37/22; C10L 2200/0446; C10L 2270/026; C10L 2290/547; C10L 2290/08; F02M 37/221

(57) ABSTRACT

An apparatus and method for removing moisture and impurities from fuel oil. An improved fuel filter or oil-water separator, which may be installed within a fuel line of an engine system, and which is adapted for removing water and particulate contaminants from the fuel. The oil-water separator provides for a two-step treatment process, wherein water and other larger particulate contaminants are first separated out from the fuel; the flue fuel from the first step is then passed through a filter cartridge to further filter out contaminants. The oil-water separator is provided with an oil cup having a drain assembly, which may be activated to drain off any water (and other contaminants) that has been separated from the fuel and collected in the oil cup.

### FIELD OF THE INVENTION

This invention relates generally to the field of oil-water separation in the treatment of diesel fuel/oil.

### BACKGROUND OF THE INVENTION

Fuel that is used for internal combustion engines (e.g. gasoline and diesel) often will contain various contaminants; this can include things such as dirt, rust particles, paint chips, and water/moisture, as well as impurities that may dissolve in or be suspended in water. In the case of diesel fuel (as compared to gasoline), water is even more likely to be a significant contaminant because diesel fuel, being less refined than gasoline, generally holds a greater amount of water in suspension. It is generally desirable to remove such contaminants from the fuel before the fuel enters the engine, since the contaminants can lead to wear-and-tear on (or even failure of) the fuel system components, such as the fuel pumps and injectors. Furthermore, having fewer contaminants in the fuel, improves the burn efficiency. These problems can be even more pronounced in the case of more modern engines, which tend to have even lower tolerances with respect to the fuel quality.

The use of the term “oil” herein is intended to mean fuel oil generally. Although the present invention is generally discussed herein in the context of an oil-water separator for diesel fuel, it should be understood that it is not limited to such and the invention and the principles disclosed may be applied to other engine fuels or fuel oils.

Conventional oil-water separation techniques for treating diesel fuel used in vehicular and other engines typically involve the use of a filter cartridge (sometimes also called a “fuel filter”) installed in the engine's fuel system. The diesel fuel is passed directly through the filter cartridge, where the fuel is filtered before being passed directly into the engine. Experience has shown that such a process cannot fully remove moisture and impurities from the diesel fuel and as such fails to satisfy the primary quality requirement of diesel fuel for engines, particularly when diesel fuel is of a comparatively poor quality (with higher moisture and impurities content). Using unclean diesel fuel in engines can lead to reduced engine performance, reduced efficiency and engine damage, which in turn will require repair and maintenance, causing inconvenience, service interruptions and cost to the user.

It is an object of the present invention to obviate or mitigate the above disadvantages.

### SUMMARY OF THE INVENTION

The present invention provides an oil-water separator which overcomes the aforementioned disadvantages.

Disclosed herein is an oil-water separator comprising: a top cover portion; a body portion attached at its upper end to the top cover portion; and an oil cup attached to the lower end of the body portion. The top cover portion comprises: an oil inlet connector; a top cover passage disposed within the top cover portion and in fluid communication with the oil inlet connector; a top cover outlet passage also disposed within the top cover portion; and an oil outlet connector which is in fluid communication with the top cover outlet passage. The body portion comprises:

a diversion tube disposed within the body portion; a tapered funnel element; a filter element housed within the body portion, and having an inlet and an outlet end; and a tapered obstacle. The diversion tube is in fluid communication with the top cover passage and the tapered funnel element. The tapered funnel element has an upper end and a lower end, wherein the lower end has a substantially narrower opening than the upper end. The tapered funnel element provides a surface to facilitate the condensation and separation of water from the fuel-water mixture. The oil cup is attached to the lower end of the body portion to together define a fluid chamber within said oil cup. The fluid chamber is in fluid communication with the tapered funnel element and in fluid communication with the inlet end of the filter element. The outlet end of the filter element is in fluid communication with the top cover outlet passage. The tapered obstacle may either be attached to the oil cup or alternatively to the lower end of the body portion. The tapered obstacle is disposed within the fluid chamber and defines a space disposed between a lower end of the fluid chamber and the inlet end of the filter element, the space having a tapered obstacle inlet and a tapered obstacle outlet, wherein the outlet has a substantially larger opening than the inlet. The oil cup is provided with a drain assembly located proximate to a lower end of the oil cup which may be activated to drain off any water that has been collected in the fluid chamber.

Numerous advantages accrue. Specifically, when the oil-water separator is installed within the fuel line of an engine system, moisture and impurities can be removed from the fuel-water mixture, thus avoiding the need for overhauls of fuel pumps and injectors/nozzles that may otherwise fail as a result of moisture and other contaminants present in the fuel. Disclosed herein is an improved oil-water separator or fuel filter, which is of compact design. The treatment of the fuel-water mixture involves two steps. Firstly, the mixture is passed through a tapered filter element, which provides a surface that the water droplets in the mixture can condense on, and separate out from the mixture. The water droplets (as well as particulate contaminants), being generally denser than the fuel, run off from the filter element and collect in the bottom of the oil cup of the oil-water separator, where the water can be drained from the oil-water separator via a drain assembly as needed. The flue fuel from the first step, from which most of the water has been removed, is then filtered using a filter cartridge to remove any remaining particulate contaminants.

Also disclosed herein is a method for removing water and other contaminants from a fuel-water mixture that is to be used in an engine, comprising the steps of: (i) passing the fuel-water mixture through an oil-water separator as disclosed above; (ii) passing the fuel-water mixture through the tapered filter element, to filter the fuel-water mixture and separate the water from the flue fuel; and (iii) passing the flue fuel through the filter element, to further filter said flue fuel.

A method for making the oil-water separator as described above is also disclosed herein.

It is therefore an object of the present invention to provide a new oil-water separator which affords advantages over other known filters and results in a device and method of use which is not anticipated, rendered obvious, suggested, or implied by any of the known filters, either alone or in any combination thereof.

### BRIEF DESCRIPTION OF THE DRAWINGS

FIG. 1 is a front cross-sectional view of an embodiment of the oil-water separator.

### DETAILED DESCRIPTION OF THE PREFERRED EMBODIMENTS

A detailed description of one or more embodiments of the invention is provided below along with the accompanying figure that illustrates the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the sake of clarity, technical material that is known in the technical fields related to the invention has not been described in detail so that the invention is not unnecessarily obscured.

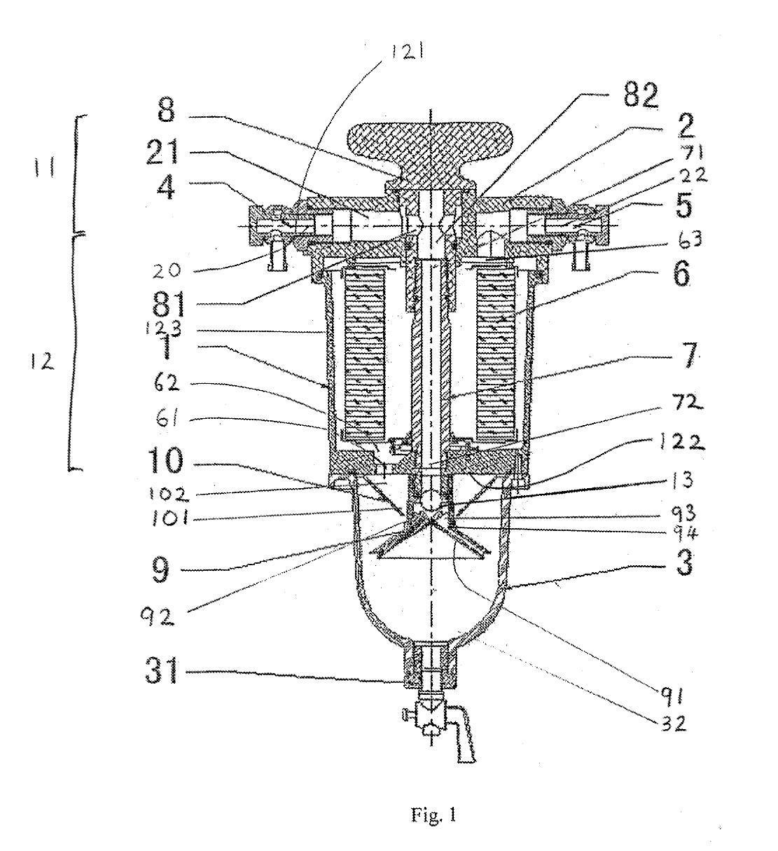

Referring to FIG. 1, an oil-water separator 1 is generally indicated, comprising a top cover portion 11, a body portion 12, and an oil cup 3. The body portion 12 is attached at its upper end 121 to the top cover portion 11, and at its lower end 122 to the oil cup 3. The top cover portion 11 comprises: an oil inlet connector 4; a top cover inlet passage 20 disposed within the top cover portion 11; a top cover 2; a T-bolt 8; a top cover outlet passage 22 which is also disposed within the top cover portion 11; and an oil outlet connector 5. The top cover inlet passage 20, as shown, comprises a top cover passage 21, through-hole 81 and a T-bolt channel 82.

The body portion 12 is shown with a casing 123. Disposed within the body portion 12 is diversion tube 7, which has an upper end 71 and a lower end 72. A tapered funnel element (also referred to herein as a tapered filter pack) 9 is attached to the lower end 122 of the body portion 12. The tapered filter pack 9 comprises a conical barrier 91 and a support member 92, to which the conical barrier 91 is attached. The support member 92 is, in turn, attached to the lower end 122 of the body portion 12. The conical barrier 91 and the support member 92 together define a funnel space of the tapered filter pack, having a upper end 93 and a lower end 94, wherein the lower end of the tapered filter pack 94 has a relatively narrower opening than the upper end of the tapered filter pack 93.

The oil cup 3 is attached to the lower end 122 of the body portion 12. The oil cup 3 and the lower end 122 of the body portion 12 together define a fluid chamber 32. The oil cup 3 is provided with a drain assembly 31, which is located at or proximate to the lower end of the oil cup 3.

A tapered obstacle 10 is also attached to the lower end 122 of the body portion 12 (the tapered obstacle 10 may optionally be attached to oil cup 3). The tapered obstacle 10 generally defines a frusto-conical shaped space within the fluid chamber 32. The tapered obstacle 10 and the tapered filter pack 9 together form a tapered obstacle inlet 101 and a tapered obstacle outlet 102, wherein the tapered obstacle inlet 101 is a relatively narrower opening than the tapered obstacle outlet 102.

Housed within the body portion 12 is a filter element or filter cartridge 6, which is generally tubular-shaped and disposed around the diversion tube 7. In a preferred embodiment, the filter cartridge 6 is in the form of a cartridge made from pleated high density filter paper. The filter cartridge 6 has an inlet end 62 and an outlet end 63.

The top cover inlet passage 20 is connected at one end to the oil inlet connector 4, and at its other end to the upper end of diversion tube 7, such that the top cover inlet passage 20 is in fluid communication with the oil inlet connector 4 and the diversion tube 7. (As used herein, two vessels are said to be “in fluid communication” when fluids therewithin may flow/move from one vessel to another). The diversion tube 7 is in turn in fluid communication with the tapered filter pack 9, which in turn is in fluid communication (via the upper end 93 and lower end 94 of the tapered filter pack 9) with the fluid chamber 32. The fluid chamber 32 in turn is in fluid communication with the filter cartridge 6 (via the tapered obstacle inlet 101, the tapered obstacle outlet 102, and the filter cartridge inlet 61). The filter cartridge inlet 61 is disposed between the tapered obstacle outlet 102 and the inlet end 62 of the filter cartridge 6. Fluid entering the inlet end of the filter cartridge 62 must pass from the outside of the filter cartridge 6, through the filter cartridge itself (thereby filtering the fluid) to the inside of the filter cartridge, where it can then pass through to the outlet end of the filter cartridge 63. The outlet end 63 of the filter cartridge 6 is in fluid communication with the top cover outlet passage 22. The top cover outlet passage 22 is connected at its other end to oil outlet connector 5, such that it is in fluid communication therewith.

Accordingly, the oil inlet connector 4, the top cover inlet passage 20, the diversion tube 7, the tapered filter pack 9 (via the upper end of the tapered filter pack 93 and lower end of the tapered filter pack 94), the fluid chamber 32, the tapered obstacle inlet 101, the tapered obstacle outlet 102, the filter cartridge inlet 61, the inlet end of the filter cartridge 62, the filter cartridge 6, the outlet end of the filter cartridge 63, the top cover outlet passage 22 and the oil outlet connector 5, together successively define a flow-path within the oil-water separator 1 for the fuel. (It should be understood that the component parts of the oil-water separator within this flow-path necessarily are fluid-“tight” and appropriately sealed).

In operation, the oil-water separator 1 is installed within the fuel line of an engine system. The fuel (which generally may contain water and other impurities) is fed into the oil-water separator 1 through oil inlet connector 4 and then passes through the top cover passage 21, the through-hole 81, the T-bolt channel 82 and the diversion tube 7 successively. Optionally, and as shown in FIG. 1, the diversion tube 7 may be provided with a one-way valve 13, which is disposed proximate to the lower end 72 of the diversion tube 7, and which is adapted to allow egress of the oil-water mixture from the diversion tube 7 to the tapered filter pack 9, but which prevents regress of the oil-water mixture into the diversion tube 7. The fuel mixture then flows into the tapered filter pack 9, comprising a conical barrier 91 and a support member 92, for the first step of the treatment process. In a preferred embodiment, the tapered filter pack 9 is made from acrylonitrile butadiene styrene (ABS) plastic. The conical barrier 91 and the support member 92 together define a funnel space, wherein the tapered filter lower end of the tapered filter pack 94 has a relatively narrower opening than the upper end of the tapered filter pack 93. This narrowing of the fluid channel has the effect of slowing down the flow of the fuel mixture as it enters the tapered filter pack 9, allowing the fuel mixture more time to pass over the conical barrier 91. The conical barrier 91 provides a surface on which water (which is generally in the form of water droplets suspended in the fuel) can condense, and separate out from the fuel mixture. The water droplets will gather to form larger droplets and, since water generally is denser than the fuel, will run off down the tapered slant of the conical barrier 91 and collect in the bottom of the fluid chamber 32 of the oil cup 3, due to gravity. Larger particulate contaminants and residue are also separated out from the fuel mixture in this fashion.

There remains pressure inside the oil-water separator 1 and as such, the flue fuel mixture obtained from the first step of the process flows into the fluid chamber 32, through the tapered obstacle inlet 101 and the tapered obstacle outlet 102 of the tapered obstacle 10. Since the tapered obstacle inlet 101 is a relatively narrower opening than the tapered obstacle outlet 102, this has the effect of slowing down the flow of the flue fuel as it enters the filter cartridge 6 via the filter cartridge inlet 61, thus facilitating the second step of the treatment process, i.e. the filtration of the flue fuel by the fuel cartridge 6. The filter cartridge 6 filters out any additional particulate contaminants (which are typically finer than separated out from the tapered filter pack 9) not removed in the first separation step. To the extent there are any water droplets that reach the filter cartridge 6, these may condense on and run off out from the filter cartridge inlet 61, through the tapered obstacle inlet 101 and into the bottom of the fluid chamber 32 of the oil cup 3. The inverted tapered configuration of the tapered obstacle 10 forms an enclosed space in the fluid chamber 32, which facilitates the separation of such impurities/contaminants.

The filtrate from this second processing step, having been filtered through the filter cartridge 6, contains very little in the way of water or other contaminants. This filtrate passes from the chamber inside the filter cartridge 6, through the top cover outlet passage 22 and exits out through the oil outlet connector 5.

By way of this two-step separation process, water and other contaminants are removed from the fuel. Some particulate contaminants are separated out either as residue which collects in the run-off from the tapered filter pack 9 in the oil cup 3, or as filter residue from the filter cartridge 6. In the case of water (and any impurities which are dissolved or suspended therein), this collects in the bottom of the fluid chamber 32 of the oil cup 3, where it can be removed as needed by drainage via the drain assembly 31. The oil cup 3 is preferably transparent to allow a user to easily inspect the oil cup 3 periodically, to ascertain when it needs to be drained.

In an embodiment of the present invention, the oil cup 3 may be removably attached to the body portion 12 via the use of one or more screws, to facilitate access to the tapered filter pack 9, for example in order to replace the first filter media 103. Optionally, the oil cup 3 may be threadably attached to the body portion 12.

In another embodiment of the present invention, the body portion 12 may be removably attached to the top cover portion 11, for example to facilitate access to the filter cartridge 6 in order to allow replacement thereof.

Also disclosed herein is a method for removing water and other contaminants from a fuel-water mixture that is to be used in an engine, comprising the steps of: passing the fuel-water mixture through an oil separator as described above;

(ii) passing the fuel-water mixture through the first filter element, to filter the fuel-water mixture and separate the water from the flue fuel; and

(iii) passing the flue fuel through the second filter element, for further filter said flue fuel.

The term “invention” and the like mean “the one or more inventions disclosed in this application”, unless expressly specified otherwise.

The title of the present application and headings of sections provided in the present application are for convenience only, and are not to be taken as limiting the scope of the disclosed invention in any way.

The embodiments described herein are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

What is claimed is:

1. A filter assembly for removing impurities from a fuel-water mixture comprising:
a top cover portion;
a body portion, having an upper and lower end, the body portion attached at the upper end to the top cover portion; and
an oil cup attached to the body portion at the lower end of the body portion;
wherein the top cover portion comprises:
an oil inlet connector;
a top cover passage disposed within the top cover portion, and in fluid communication with the oil inlet connector; and
a top cover outlet passage disposed within the top cover portion, and an oil outlet connector in fluid communication with the top cover outlet passage;
wherein the body portion comprises:
a diversion tube disposed within the body portion, the diversion tube having an upper end and a lower end, wherein the upper end of the diversion tube is in fluid communication with the top cover passage;
a tapered funnel element, comprising a conical barrier and a support member, wherein the support member is attached to said conical barrier and the lower end of the body portion, the conical barrier and the support member together defining a funnel space having a upper end and a lower end, wherein the lower end has a substantially narrower opening than the upper end, wherein the tapered funnel element is in fluid communication with the diversion tube and provides a surface to facilitate the condensation and separation of water from the fuel-water mixture;
a filter element housed within the body portion, and having an inlet end and an outlet end; and
a tapered obstacle;
wherein the oil cup and the lower end of the body portion define a fluid chamber within said oil cup, wherein the fluid chamber is in fluid communication with the tapered funnel element and in fluid communication with the inlet end of the filter element, and wherein the outlet end of the filter element is in fluid communication with the top cover outlet passage;
wherein the oil cup is provided with a drain assembly located proximate to a lower end of the oil cup for draining water from the fluid chamber; and
wherein the tapered obstacle is disposed within the fluid chamber and defines a space disposed between a lower end of the fluid chamber and the inlet end of the second filter element, the space having a tapered obstacle inlet and a tapered obstacle outlet, wherein the tapered obstacle outlet has a substantially larger opening than the tapered obstacle inlet.

2. A filter assembly according to claim 1, wherein the fuel-water mixture is diesel fuel.

3. A filter assembly according to claim 1, wherein the diversion tube is equipped with a one-way valve disposed proximate to the lower end of the dispersion tube, the one-way valve permitting egress of the fuel-water mixture from the dispersion tube to the tapered funnel element but preventing regress of said fuel-water mixture.

4. A filter assembly according to claim 1, wherein the filter element is a filter cartridge made from high density filter paper.

5. A filter assembly according to claim 1, wherein the oil cup is removably attached to the lower end of the body portion.

6. A filter assembly according to claim 2, wherein the oil cup is threadably attached to the lower end of the body portion.

7. A filter assembly according to claim 1, wherein the body portion is removably attached to the top cover portion.

8. A method for removing water and contaminants from a fuel-water mixture that is to be used in an engine comprising the steps of:
(i) passing the fuel-water mixture through a filter assembly, said filter assembly comprising:
a top cover portion;
a body portion, having an upper and lower end, the body portion attached at the upper end to the top cover portion; and
an oil cup attached to the body portion at the lower end of the body portion;
wherein the top cover portion comprises:
an oil inlet connector;
a top cover passage disposed within the top cover portion, and in fluid communication with the oil inlet connector; and
a top cover outlet passage disposed within the top cover portion, and an oil outlet connector in fluid communication with the top cover outlet passage;
wherein the body portion comprises:
a diversion tube disposed within the body portion, the diversion tube having an upper end and a lower end, wherein the upper end of the diversion tube is in fluid communication with the top cover passage;
a tapered funnel element, comprising a conical barrier and a support member, wherein the support member is attached to said conical barrier and the lower end of the body portion, the conical barrier and the support member together defining a funnel space having a upper end and a lower end, wherein the lower end has a substantially narrower opening than the upper end, wherein the tapered funnel element is in fluid communication with the diversion tube and provides a surface to facilitate the condensation and separation of water from the oil-water mixture;
a filter element housed within the body portion, and having an inlet end and an outlet end; and
a tapered obstacle;
wherein the oil cup and the lower end of the body portion define a fluid chamber within said oil cup, wherein the fluid chamber is in fluid communication with the tapered funnel element and in fluid communication with the inlet end of the filter element, and wherein the outlet end of the filter element is in fluid communication with the top cover outlet passage;
wherein the oil cup is provided with a drain assembly located proximate to a lower end of the oil cup for draining water from the fluid chamber; and
wherein the tapered obstacle is disposed within the fluid chamber and defines a space disposed between a lower end of the fluid chamber and the inlet end of the second filter element, the space having a tapered obstacle inlet and a tapered obstacle outlet, wherein the tapered obstacle outlet has a substantially larger opening than the tapered obstacle inlet.
(ii) passing the fuel-water mixture through the tapered funnel element in order to condense and separate out water from the fuel-water mixture, to produce flue fuel that has had substantially most of the water removed therefrom; and
(iii) passing the flue fuel through the filter element to filter out contaminants therefrom.

9. The method of claim 8, wherein the fuel-water mixture is diesel fuel.

10. The method of claim 8, wherein the diversion tube is equipped with a one-way valve disposed proximate to the lower end of the dispersion tube, the one-way valve permitting egress of the fuel-water mixture from the dispersion tube to the tapered funnel element but preventing regress of said fuel-water mixture.

11. The method of claim 8, wherein the filter element is a filter cartridge made from high density filter paper.

12. The method of claim 8, wherein the oil cup is removably attached to the lower end of the body portion.

13. The method of claim 8, wherein the oil cup is threadably attached to the lower end of the body portion.

14. The method of claim 8, wherein the body portion is removably attached to the top cover portion.

15. A method of making a filter assembly for removing impurities from a fuel-water mixture, comprising the steps of:
providing a top cover portion;
attaching a body portion, having an upper and lower end, to the top cover portion at the upper end of the body portion; and
attaching an oil cup to the lower end of the body portion;
wherein the top cover portion comprises:
an oil inlet connector;
a top cover passage disposed within the top cover portion, and in fluid communication with the oil inlet connector; and
a top cover outlet passage disposed within the top cover portion, and an oil outlet connector in fluid communication with the top cover outlet passage;
wherein the body portion comprises:
a diversion tube disposed within the body portion, the diversion tube having an upper end and a lower end, wherein the upper end of the diversion tube is in fluid communication with the top cover passage;
a tapered funnel element, comprising a conical barrier and a support member, wherein the support member is attached to said conical barrier and the lower end of the body portion, the conical barrier and the support member together defining a funnel space having a upper end and a lower end, wherein the lower end has a substantially narrower opening than the upper end, wherein the tapered funnel element is in fluid communication with the diversion tube and provides a surface to facilitate the condensation and separation of water from the fuel-water mixture;
a filter element housed within the body portion, and having an inlet end and an outlet end; and
a tapered obstacle;
wherein the oil cup and the lower end of the body portion define a fluid chamber within said oil cup, wherein the fluid chamber is in fluid communication with the tapered funnel element and in fluid communication with the inlet end of the filter element, and wherein the outlet end of the filter element is in fluid communication with the top cover outlet passage;
wherein the oil cup is provided with a drain assembly located proximate to a lower end of the oil cup for draining water from the fluid chamber; and
wherein the tapered obstacle is disposed within the fluid chamber and defines a space disposed between a lower end of the fluid chamber and the inlet end of the second filter element, the space having a tapered obstacle inlet and a tapered obstacle outlet, wherein the tapered obstacle outlet has a substantially larger opening than the tapered obstacle inlet.
